(19) United States
(12) Patent Application Publication
(10) Pub. No.: US 2025/0105646 A1
(43) Pub. Date: Mar. 27, 2025

(54) PASS THROUGH MODE IN BATTERY CHARGER

(71) Applicant: Renesas Electronics America Inc., Milpitas, CA (US)

(72) Inventors: Sungkeun LIM, Apex, NC (US); Yen-Mo CHEN, Morrisville, NC (US); Chong HAN, Cary, NC (US); Dongwoo HAN, Raleigh, NC (US)

(73) Assignee: Renesas Electronics America Inc., Milpitas, CA (US)

(21) Appl. No.: 18/473,606

(22) Filed: Sep. 25, 2023

(51) Int. Cl. H02J 7/00

(52) U.S. Cl. CPC H02J 7/00712; H02J 7/0047; H02J 7/0068

(57) ABSTRACT

Systems and methods for operating a battery charger are described. A controller can operate a battery charger under a charging mode to use an adapter power to support a system power of the battery charger. The controller can detect the adapter power reaches a maximum, transition the battery charger into a discharging mode to decrease a battery charging current in the battery charger to support the system power and decrease a system voltage at the output of the battery charger. The controller can detect the system voltage is less than a battery voltage of the battery by an offset and transition the battery charger from the discharging mode to a pass-through mode that continues to discharge the battery, where the PTM can cause the battery charger to discharge the battery without performing switching.

### BACKGROUND OF THE SPECIFICATION

The present disclosure relates in general to semiconductor devices. More specifically, the present disclosure relates to operating a battery charger in a discharging mode that includes a pass through mode.

Devices that include battery chargers can include one or more ports, such as a universal serial bus (USB) port, that receives power. The received power can be used for charging one or more batteries in the device, and/or for providing power to a load in the device or a load connected to the device. The battery charger can include one or more charger modules, and each port (or each USB port) can be connected to an individual charger module. The battery charger can further include a controller configured to control operations of the charger module. The battery charger can further include various circuits and integrated circuits (IC) that can detect various quantitative measurements of the battery charger. The detected quantitative measurements can be provided to one or more control loops implemented by the controller and the controller can adjust parameters and/or settings of the charger module to optimize performances such as efficiency and power consumption, and to prevent hazardous conditions related to the battery charger.

### SUMMARY

In one embodiment, a method for operating a battery charger is generally described. The method can include operating a battery charger under a charging mode to use an adapter power to support a system power at an output of the battery charger. The method can further include detecting the adapter power reaches a maximum value. The method can further include, in response to the adapter power reaching the maximum value, transitioning the battery charger from the charging mode to a discharging mode to decrease a battery charging current in the battery charger to support the system power. A system voltage at the output of the battery charger can start to decrease in response to the decreased battery charging current. The method can further include detecting the system voltage is less than a battery voltage of the battery by a predefined voltage offset. The method can further include, in response to detecting the system voltage being less than the battery voltage by the predefined voltage offset, transitioning the battery charger from the discharging mode to a pass-through mode (PTM) that continues to discharge the battery. The PTM can cause the battery charger to discharge the battery without performing switching.

In one embodiment, a semiconductor device for operating a battery charger is generally described. The semiconductor device can include a controller configured to operate a battery charger under a charging mode to use an adapter power to support a system power at an output of the battery charger. The controller can detect the adapter power reaches a maximum value. The controller can, in response to the adapter power reaching the maximum value, transition the battery charger from the charging mode to a discharging mode to decrease a battery charging current in the battery charger to support the system power. A system voltage at the output of the battery charger can start to decrease in response to the decreased battery charging current. The controller can further detect the system voltage is less than a battery voltage of the battery by a predefined voltage offset. The controller can, in response to detection that the system voltage is less than the battery voltage by the predefined voltage offset, further transition the battery charger from the discharging mode to a pass-through mode (PTM) that continues to discharge the battery. The PTM can cause the battery charger to discharge the battery without performing switching.

In one embodiment, an apparatus for operating a battery charger is generally described. The apparatus can include a power delivery circuit configured to convert an input voltage into an adapter voltage. The apparatus can further include a switch converter configured to switch the adapter voltage into a midpoint voltage. The apparatus can further include a battery charger. The apparatus can further include a battery. The battery charger can be configured to operate under a charging mode to use an adapter power provided by the midpoint voltage to support a system power at an output of the battery charger. The battery charger of the apparatus can be further configured to detect the adapter power reaches a maximum value. The battery charger can be further configured to, in response to the adapter power reaching the maximum value, transition the battery charger from the charging mode to a discharging mode to decrease the battery charging current to support the system power. A system voltage at the output of the battery charger can start to decrease in response to the decreased battery charging current. The battery charger can be further configured to detect the system voltage is less than a battery voltage of the battery by a predefined voltage offset. The battery charger can be configured to, in response to detection that the system voltage being less than the battery voltage by the predefined voltage offset, further transition the battery charger from the discharging mode to a pass-through mode (PTM) that continues to discharge the battery. The PTM can cause the battery charger to discharge the battery without performing switching.

The foregoing summary is illustrative only and is not intended to be in any way limiting. In addition to the illustrative aspects, embodiments, and features described above, further aspects, embodiments, and features will become apparent by reference to the drawings and the following detailed description. In the drawings, like reference numbers indicate identical or functionally similar elements.

### BRIEF DESCRIPTION OF THE DRAWINGS

FIG. 1 is a diagram showing an apparatus that can implement pass through mode in battery charger in one embodiment.

FIG. 2A is a diagram showing a set of control loops that can be used for implementing pass through mode in battery charger in one embodiment.

FIG. 2B is a diagram showing another set of control loops that can be used for implementing pass through mode in battery charger in one embodiment.

FIG. 3 is a diagram showing waveforms that can result from an implementation of pass through mode in battery charger in one embodiment.

FIG. 4 is a flowchart of an example process that can implement pass through mode in battery charger in one embodiment.

### DETAILED DESCRIPTION

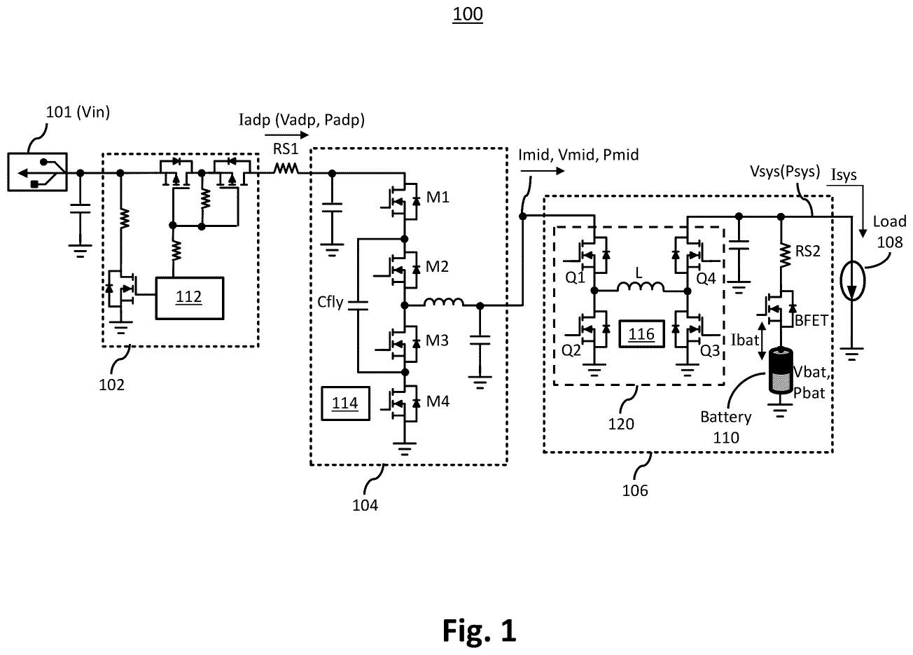

FIG. 1 is a diagram showing an apparatus that can implement pass through mode in battery charger in one embodiment. An apparatus 100, shown in FIG. 1, can include a port 101, a power delivery circuit 102, a first stage 104, a second stage 106 and a battery module 110. In one embodiment, port 101 can be a universal serial bus C-type (USB-C) port. In one embodiment, a load 108 can be connected to apparatus 100 (e.g., connected to an output of second stage 106). In another embodiment, load 108 can be a part of apparatus 100. Apparatus 100 can be an electronic device, such as, for example, a desktop computer, a laptop computer, a tablet device, a smartwatch, a cellular phone, a smartphone, a wearable device, an e-cigarette, or the like. Battery module 110 can be a battery pack including at least one battery.

Power delivery circuit 102 can include a controller 112 that control various aspects of power delivery circuit 102, such as determining source and sink, negotiation and authentication for charging devices, determining charging direction, operating components such as switches in power delivery circuit 102, or the like. In one embodiment, power delivery circuit 102 can be an extended power range (EPR) power delivery (PD) adapter for USB-C ports that supports high voltage power delivery (e.g., universal serial bus power delivery (USB-PD) version 3.1. By way of example, input voltage Vin at port 101 can be up to 48 volts (V) such that power delivery circuit 102 can output an adapter power Padp up to 240 watts (W) with a maximum current limit set to 5 amperes (A).

First stage 104 can be a first voltage conversion stage that converts an input voltage Vin received at port 101 into a midpoint voltage Vmid. First stage 104 can be implemented by multilevel switch converter, such as a three-level buck converter, formed by switching elements M1, M2, M3, M4 and a flying capacitor Cfly. Switching elements M1, M2, M3, M4 can be metal-oxide-semiconductor field-effect transistors (MOSFET) and can be connected in series. A controller 114, which can be a three-level buck controller, can be configured to switch switching elements M1, M2, M3, M4 and control a voltage of Cfly. By way of example, since first stage 104 is implemented by a three-level buck converter, first stage 104 can alternatively output its output voltage as voltages 0V, Vadp/2 and Vadp to generate proper Vmid. adapter power Padp can be supplied from power delivery circuit 102 to second stage 106 via first stage 104.

Second stage 106 can be a narrow voltage direct charging (NVDC) battery charger (e.g., a NVDC 4-switch buck-boost battery charger). Second stage 106 can be configured to convert or regulate Vmid into Vsys. The combination of first stage 104 and second stage 106 can allow Vin to be extended to relatively high voltages, such as 48V. Second stage 106 can include a converter 120 formed by switching elements Q1, Q2, Q3, Q4 arranged in a full-bridge configuration and an inductor L. Power from first stage 104, such as Pmid, can be provided to load 108 and battery module 110 for charging battery module 110. Second stage 106 being a NVDC charger can allow Vsys to be regulated at a voltage near the battery voltage Vbat. A controller 116 can be configured to control switching elements Q1, Q2, Q3, Q4 based on various control loops. A switching element BFET can be connected between battery module 110 and Vsys. Switching elements Q1, Q2, Q3, Q4, BFET can be MOSFETs.

Controllers 112, 114, 116 can be, for example, microcontrollers. Controllers 112, 114, 116 can further include components, such as processors, logic circuits, digital to analog converters (DACs), comparators, mixers, memory devices (e.g., registers), and various electronic components. Controllers 112, 114, 116 can also include memory devices, such as registers, configured to store various predefined reference and threshold values that may be needed for operating power delivery circuit 102, first stage 104 and second stage 106. In one embodiment, controllers 112, 114, 116 can be configured to be in communication with one another. In one embodiment, controllers 112, 114, 116 can be parts of a single microcontroller.

Apparatus 100 can operate second stage 106 in various modes to support (e.g., provide or supply power) system power Psys being provided to load 108. If battery module 110 is fully charged, controller 116 can turn off BFET. Pmid delivered by Vmid can support Psys (e.g., Padp being the power provided to load 108). Second stage 106 can operate under a charging mode, such as an NVDC mode, when Padp is greater than Psys and battery module 110 is not fully charged. Under NVDC mode, Padp can support Psys and can charge battery module 110 through converter 106. Controller 116 can turn on BFET under NVDC mode. Second stage 106 can operate under a discharging mode, such as a turbo mode, when Padp is less than Psys. Since Padp is less than Psys, Padp may be insufficient to support Psys. Thus, battery module 106 can be discharged to provide power to Psys, resulting in both Padp and Pbat supporting Psys. Controller 116 can turn on BFET under turbo mode.

As Psys increases, Psys will eventually become greater than Padp. In response to Psys being greater than Padp, second stage 106 can begin turbo mode to discharge battery module 110 for supplementing Psys Conventional devices, such as devices that use bypass transistors to operate charging mode (e.g., bypass charging mode), and discharging mode (e.g., reverse-turbo-boost (RTB) mode), can incur a delay when transitioning from charging mode to discharging mode. During this delay, Psys is not supported, and the RTB mode involves switching (e.g., in converter 120) that causes thermal issues and power loss.

To be described in more detail below, apparatus 100 can transition from charging mode, such as NVDC charging mode, to a discharging mode, such as an NVDC discharging mode, then under a specific condition, further transition into a pass-through mode (PTM) to continue the discharge without switching. When Vsys>Vbat−200 mV, PTM can be disabled and enters NVDC discharging mode once again. Using PTM in the discharging mode can allow apparatus 100 to transition from a charging mode to a discharging mode without delay and PTM does not incur switching loss (when compared to conventional techniques such as NVDC mode with bypass transistors). The reduced switching can also improve thermal performance. In an aspect, PTM can be an operation mode where switching elements Q1, Q4 remain turned on while switching elements Q2, Q3 are turned off. Thus, no switching is involved when second stage 106 operates under PTM. Controller 116 can be configured to monitor currents and voltages at various points of apparatus 100 and select specific control loops based on the monitored currents and voltages. The monitoring and selection of control loops can cause controller 116 to transition from NVDC discharging mode into PTM at an appropriate time.

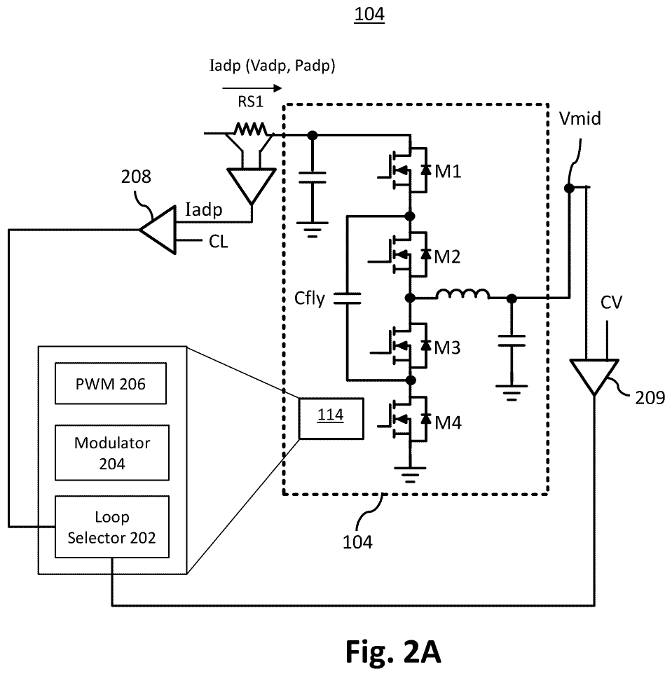

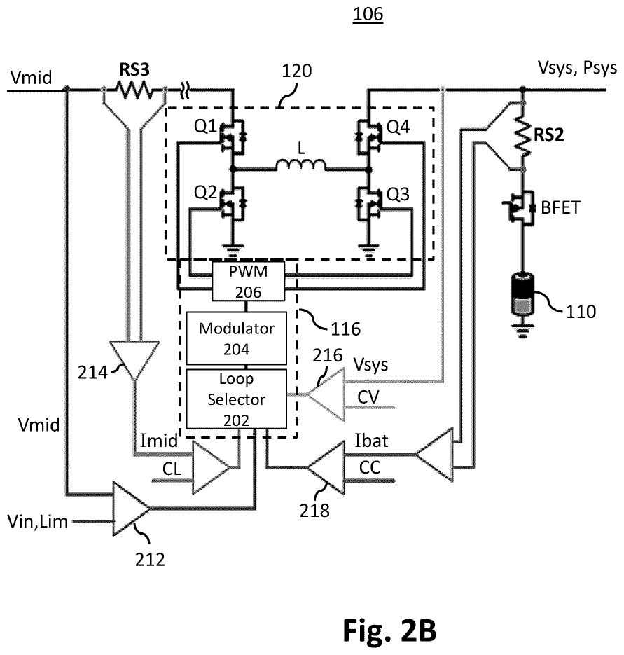

FIG. 2A is a diagram showing a set of control loops that can be used for implementing pass through mode in battery charger in one embodiment. The description of FIG. 2A can reference components that are shown in FIG. 1. In an embodiment shown in FIG. 2A, controller 114 of FIG. 1 can include at least a loop selector 202a, a modulator 204b and a pulse width modulation (PWM) driver 206c. First stage 104 can include various comparators configured to monitor currents and voltages at the input and output of first stage 104.

In the embodiment shown in FIG. 2A, a comparator 208 can receive Iadp that can be measured across RS1. Comparator 208 can also receive a predefined current limit CL. An Iadp control loop can be a control loop that flows from RS1 to first stage 104 via controller 114. When loop selector 202a selects the Iadp control loop, modulator 204a can generate a Iadp control signal and PWM driver 206a can use the Iadp control signal to drive M1, M2, M3, M4 to regulate Iadp at CL.

When Psys is greater than Padp, loop selector 202a can select the Iadp control loop to monitor whether Iadp reaches current limit CL. In response to Iadp reaching current limit CL, controller 114 can start to reduce Vmid. When Vmid decreases to V_{in,Lim}, loop selector 202b can select the Vin control loop for controller to regulate Vmid at V_{in,Lim}. Referring to FIG. 2B, when Vmid is being regulated at V_{in,Lim}, Vsys and Ibat can continue to decrease and battery module 110 can be discharged, under NVDC discharging mode, to support Psys. Also, under the NVDC discharging mode, converter 120 can continue switching, BFET can be turned on while second stage 106 enters Vin loop, and Ibat starts to decrease in response to decreased Vsys to discharge battery module 110 (e.g., Pbat=Psys−Padp).

FIG. 2B is a diagram showing another set of control loops that can be used for implementing pass through mode in battery charger in one embodiment. The description of FIG. 2B can reference components that are shown in FIG. 1 and FIG. 2A. In an embodiment shown in FIG. 2B, controller 116 of FIG. 1 can include at least a loop selector 202b, a modulator 204b and a pulse width modulation (PWM) driver 206b. Second stage 106 can include various comparators configured to monitor currents and voltages at the input and output of second stage 106.

In the embodiment shown in FIG. 2B, a comparator 212 can receive Vmid that can be measured between the output of first stage 104 and the input of second stage 106. Comparator 212 can also receive a predefined input voltage Vin,Lim defining a target Vmid from a digital-to-analog converter (DAC) register in second stage 106. In one embodiment, Vin,Lim can be a predefined input voltage for regulating Vmid in response to a start of discharging battery module 110. A Vmid control loop can be a control loop that flows from Vmid to converter 120 via comparator 212 and controller 116. When loop selector 202b selects the Vmid control loop, modulator 204b can generate a Vmid control signal and PWM driver 206b can use the Vmid control signal to drive Q1, Q2, Q3, Q4 to regulate Vmid at Vin,Lim.

A comparator 214 can receive adapter current Imid measured across a sense resistor RS3. Comparator 214 can also receive a predefined current CL defining a current limit of Imid from another DAC register in second stage 106. Current limit CL can be a maximum allowed value of Imid that would regulate power from second stage 106, or Psys, at a maximum power. An Imid control loop can be a control loop that flows from RS3 to converter 120 via comparator 214 and controller 116. When loop selector 202b selects the Imid control loop, modulator 204b can generate a Imid control signal and PWM driver 206b can use the Imid control signal to drive Q1, Q2, Q3, Q4 to regulate Imid at CL.

A comparator 216 can receive a charger voltage, such as Vsys measured from an output of converter 120. Comparator 216 can also receive a predefined voltage CV defining a target charge voltage for Vsys, from another DAC register in second stage 106.—A Vsys control loop can be a control loop that flows from Vsys to converter 120 via comparator 216 and controller 116. When loop selector 202b selects the Vsys control loop, modulator 204b can generate a Vsys control signal and PWM driver 206b can use the Vsys control signal to drive Q1, Q2, Q3, Q4 to regulate Vsys at CV.

A comparator 218 can receive a charge current Ibat measured across sense resistor RS2. Comparator 218 can also receive a predefined current defining a charge current CC from another DAC register in second stage 106. Charge current CC can be a current limit of the battery current Ibat. An Ibat control loop can be a control loop that flows from RS2 to converter 120 via comparator 218 and controller 116. When loop selector 202b selects the Ibat control loop, modulator 204b can generate a Ibat control signal and PWM driver 206b can use the Ibat control signal to drive Q1, Q2, Q3, Q4 to regulate Ibat at CC.

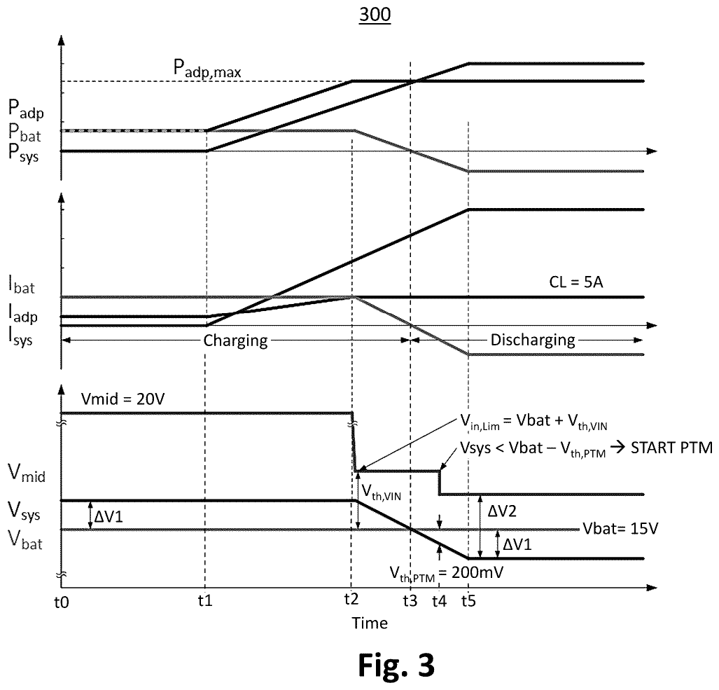

When Vsys decreases to a voltage less than Vbat by a predefined voltage offset V_{th,PTM}, (e.g., Vsys<Vbat−V_{th,PTM}) , controller 106 can enable PTM by turning off switching elements Q2, Q3 and turning on switching elements Q1, Q4. The predefined value V_{th,PTM} can be an offset voltage between Vsys and Vbat that defines a threshold voltage to trigger a start of PTM. When Vsys>Vbat−V_{th,PTM}, controller 116 can disable PTM and return to regular switching of converter 120. Further details of the transition from charging mode (e.g., NVDC mode) to NVDC discharging mode, then PTM, will be shown in FIG. 3.

FIG. 3 is a diagram showing waveforms that can result from an implementation of pass through mode in battery charger in one embodiment. The description of FIG. 3 can reference components that are shown in FIG. 1 and FIG. 2. In the example shown in FIG. 3, at a time t0, Vmid is being regulated at an initial voltage of 20V. A voltage difference ΔV1 between Vsys and Vbat can be Ibat(charging)×(R_{DS(ON), BGATE}+RS2), where Ibat(charging) denotes a current flowing into battery module 110 under charging mode, R_{DS(ON), BGATE} denotes a resistance between the drain and the source of BFET when a specific gate-to-source voltage (VGS) is applied to bias BFET to the on state and RS2 is the resistance of sense resistor RS2.

At time t1, Psys can start to increase, which increases Padp and Iadp while Vmid is still being regulated at 20V. The increase to Isys and Psys can also increase Iadp and Padp while Ibat keeps the same charging current.

At time t2, Iadp can reach current limit CL. Since Padp reaches its maximum value, first stage 104 decreases Vmid to maintain Iadp at current limit CL, and second stage 106 enters to Vin loop to maintain V_{in,Lim}. After then, battery module 110 can begin to decrease the charging current at time t2 in order to support Psys (e.g., to keep increasing Psys), thus entering NVDC discharging mode. Battery current Ibat can start to decrease at t2 as battery module 110 starts to decrease the charging current.

At time t3, Psys starts to become greater than Padp and Vsys starts to become less than Vbat. In response to Psys being greater than Padp, controller 116 can monitor a difference between Vsys and Vbat to detect an appropriate time to transition from NVDC charging mode to PTM.

At time t4, Vsys is decreased to a voltage level that is less than Vbat by offset voltage V_{th,PTM}, such as 200 mV. In response to Vsys being less than Vbat by V_{th,PTM}, controller 116 can transition from NVDC discharging mode to PTM by switching off switching elements Q2, Q3 and turning on switching elements Q1, Q4. When PTM is enabled, Vmid can be further reduced by the first stage's Iadp current limit control.

At time t5, when Psys reaches at maximum power, Ibat keeps discharging current. If Psys is decreased and Vsys becomes greater than Vbat−V_{th,PTM}, controller 116 can transition from PTM to NVDC discharging mode. When Vmid is being regulated by first stage 104 under CL loop and second stage 106 is under PTM, a difference between Vmid and Vsys is ΔV2=IL×(DCR_{L}+R_{DS(ON), Q1&Q4}), where IL is the current flowing through inductor L under PTM, DCR_{L} is the DC resistance of inductor L under PTM, and R_{DS(ON), Q1&Q4} denotes a resistance between the drain and the source of switching elements Q1 and Q4 when VGS is applied to bias Q1 and Q4 to the on state.

By regulating Vmid at multiple voltage levels, such as at V_{in,Lim,} second stage 106 reduce Vsys resulting in transition from a charging mode to a discharging mode seamlessly by VIN loop. The regulation of Vmid at V_{in,Lim} allows Psys to get uninterrupted support from Padp (e.g., via the Vmid regulated at V_{in,Lim}) and Pbat, and allows ample time for controller 116 to monitor Vsys and identify an appropriate time to start PTM. The values of V_{in,Lim}, V_{th,VIN}, and V_{th,PTM} can be chosen to accommodate different implementations. In one embodiment, the values of V_{th,PTM} and V_{th,VIN} can be arbitrary and can depend on system parameters such as BFET's RDS,(ON), RS2, and other parameters. Using a discharging mode that includes PTM can reduce switching of switching elements Q1, Q2, Q3, Q4 in converter 120. The reduced switching can reduce switching loss and improve efficiency and thermal performance of apparatus 100.

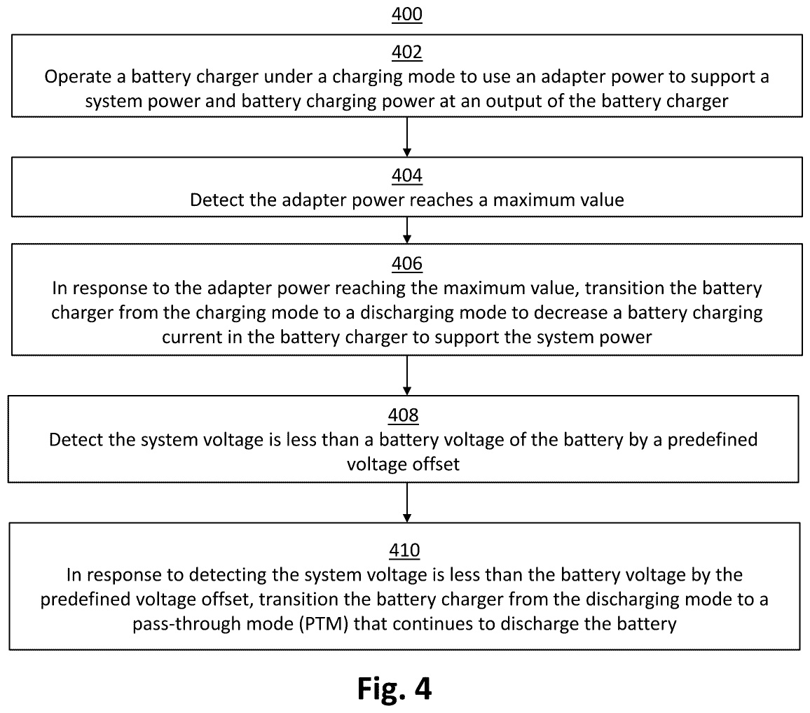

FIG. 4 is a flowchart of an example process that can implement pass through mode in battery charger in one embodiment. A process 400 in FIG. 4 may be implemented using, for example, apparatus 100 discussed above. Process 400 can include one or more operations, actions, or functions as illustrated by one or more of blocks 402, 404, and/or 406. Although illustrated as discrete blocks, various blocks may be divided into additional blocks, combined into fewer blocks, eliminated, performed in different order, or performed in parallel, depending on the desired implementation.

Process 400 can be implemented by a controller of a power sink device, such as a controller of a battery charger. Process 400 can begin at block 402, where the controller can operate a battery charger under a charging mode to use an adapter power to support a system power, and battery charging power, at an output of the battery charger. The process 400 can continue from block 402 to block 404. At block 404, the controller can detect the adapter power reaches a maximum value and the first stage operate under input current loop. Also at block 404, a first stage of the battery charger can operate under an input current limit loop and a midpoint voltage provided from the first stage to a second stage of the battery charger can start to decrease. The process 400 can continue from block 404 to block 406. At block 406, the controller can in response to the adapter power reaching the maximum value, transition the battery charger from the charging mode to a discharging mode to a battery charging current to support the system power. A system voltage at the output of the battery charger starts to decrease in response to the decreased battery charging current. When the system power is greater than the adapter power, the battery can start to discharge. Also in block 406, in response to the midpoint voltage being decreased in block 404, the second stage can operate under an input voltage loop to maintain the midpoint voltage at an input voltage limit (see V_{in,Lim} in FIG. 3 and described above) and start to decrease the system voltage. In response to the decreased system voltage, the charging current can be decreased, and the battery starts to discharge.

The process 400 can continue from block 406 to block 408. At block 408, the controller can detect the system voltage can be less than a battery voltage of the battery by a predefined voltage offset. The process 400 can continue from block 408 to block 410. At block 410, the controller can, in response to detecting the system voltage can be less than the battery voltage by the predefined voltage offset (e.g., system voltage<battery voltage−predefined voltage offset), transition the battery charger from the discharging mode to a pass-through mode (PTM) that continues to discharge the battery. The PTM can cause the battery charger to discharge the battery without performing switching, hence discharging the battery without switching losses.

In one embodiment, the battery charger can include a first high side switching element, a second high side switching element, a first low side switching element and a second low side switching element. The controller can further transition the battery charger from the charging mode to the PTM by turning on the first high side switching element and the second high side switching element and turning off the first low side switching element and the second low side switching element.

In another embodiment, in response to the start of the PTM, the controller can further reduce the input voltage to a target voltage under the PTM and regulate the input voltage at the target voltage under the PTM. In another embodiment, the controller can further maintain an input voltage to the battery charger at a voltage level greater than the system voltage. In another embodiment, an input voltage to the battery charger and the system voltage are shorted under the PTM. In another embodiment, the charging mode can be a narrow voltage direct charging (NVDC) mode and the discharging mode can be a NVDC discharging mode.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be implemented substantially concurrently, or the blocks may sometimes be implemented in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements, if any, in the claims below are intended to include any structure, material, or act for performing the function in combination with other claimed elements as specifically claimed. The disclosed embodiments of the present invention have been presented for purposes of illustration and description but are not intended to be exhaustive or limited to the invention in the forms disclosed. Many modifications and variations will be apparent to those of ordinary skill in the art without departing from the scope and spirit of the invention. The embodiments were chosen and described in order to best explain the principles of the invention and the practical application, and to enable others of ordinary skill in the art to understand the invention for various embodiments with various modifications as are suited to the particular use contemplated.

What is claimed is:

1. A method for operating a battery charger, the method comprising:
operating a battery charger under a charging mode to use an adapter power to support a system power at an output of the battery charger;
detecting the adapter power reaches a maximum value;
in response to the adapter power reaching the maximum value, transitioning the battery charger from the charging mode to a discharging mode to decrease a battery charging current in the battery charger to support the system power, wherein a system voltage at the output of the battery charger starts to decrease in response to the decreased battery charging current;
detecting the system voltage is less than a battery voltage of the battery by a predefined voltage offset; and
in response to detecting the system voltage is less than the battery voltage by the predefined voltage offset, transitioning the battery charger from the discharging mode to a pass-through mode (PTM) that continues to discharge the battery, wherein the PTM causes the battery charger to discharge the battery without performing switching.

2. The method of claim 1, wherein the battery charger comprises a first high side switching element, a second high side switching element, a first low side switching element and a second low side switching element, and transitioning the battery charger from the charging mode to the PTM comprises turning on the first high side switching element and the second high side switching element and turning off the first low side switching element and the second low side switching element.

3. The method of claim 1, further comprising:
in response to the adapter power reaching the maximum value, reducing an input voltage to the battery charger until the input voltage reaches a predefined input voltage; and
regulating the input voltage at the predefined input voltage until a start of the PTM.

4. The method of claim 3, further comprising:
in response to the adapter power reaching the maximum value:
operating a first stage of the battery charger under an input current limit loop;
decreasing a midpoint voltage being provided from the first stage to a second stage of the battery charger;
in response to the midpoint voltage being decreased:
operating the second stage under an input voltage loop to maintain the midpoint voltage at an input voltage limit;
decreasing the system voltage; and
in response to the system voltage being decreased, decreasing the battery charging current.

5. The method of claim 1, further comprising maintaining an input voltage to the battery charger at a voltage level greater than the system voltage.

6. The method of claim 1, wherein an input voltage to the battery charger and the system voltage are shorted under the PTM.

7. The method of claim 1, wherein the charging mode is a narrow voltage direct charging (NVDC) mode and the discharging mode is an NVDC discharging mode.

8. A semiconductor device comprising:
a controller configured to:
operate a battery charger under a charging mode to use an adapter power to support a system power at an output of the battery charger;
detect the adapter power reaches a maximum value;
in response to the adapter power reaching the maximum value, transition the battery charger from the charging mode to a discharging mode to decrease a battery charging current in the battery charger to support the system power, wherein a system voltage at the output of the battery charger starts to decrease in response to the decreased battery charging current;
detect the system voltage is less than a battery voltage of the battery by a predefined voltage offset; and
in response to detection that the system voltage is less than the battery voltage by the predefined voltage offset, transition the battery charger from the discharging mode to a pass-through mode (PTM) that continues to discharge the battery, wherein the PTM causes the battery charger to discharge the battery without performing switching.

9. The semiconductor device of claim 8, wherein the battery charger comprises a first high side switching element, a second high side switching element, a first low side switching element and a second low side switching element, and the controller is configured to turn on the first high side switching element and the second high side switching element and turn off the first low side switching element and the second low side switching element to transition the battery charger from the charging mode to the PTM.

10. The semiconductor device of claim 8, wherein the controller is configured to:
in response to the adapter power reaching the maximum value, reduce an input voltage to the battery charger until the input voltage reaches a predefined input voltage; and
regulate the input voltage at the predefined input voltage until a start of the PTM.

11. The semiconductor device of claim 10, wherein the controller is configured to:
in response to the adapter power reaching the maximum value:
operate a first stage of the battery charger under an input current limit loop;
decrease a midpoint voltage being provided from the first stage to a second stage of the battery charger;
in response to the midpoint voltage being decreased:
operate the second stage under an input voltage loop to maintain the midpoint voltage at an input voltage limit;
decrease the system voltage; and
in response to the system voltage being decreased, decrease the battery charging current.

12. The semiconductor device of claim 10, wherein the controller is configured to maintain an input voltage to the battery charger at a voltage level greater than the system voltage.

13. The semiconductor device of claim 10, wherein an input voltage to the battery charger and the system voltage are shorted under the PTM.

14. The semiconductor device of claim 10, wherein the charging mode is a narrow voltage direct charging (NVDC) mode and the discharging mode is an NVDC discharging mode.

15. An apparatus comprising:
a power delivery circuit configured to convert an input voltage into an adapter voltage;
a switch converter configured to switch the adapter voltage into a midpoint voltage;
a battery charger; and
a battery;
the battery charger is configured to:
operate under a charging mode to use an adapter power provided by the midpoint voltage to support a system power at an output of the battery charger;
detect the adapter power reaches a maximum value;
in response to the adapter power reaching the maximum value, transitioning the battery charger from the charging mode to a discharging mode to decrease a battery charging current to support the system power, wherein a system voltage at the output of the battery charger starts to decrease in response to the decreased battery charging current;
detect the system voltage is less than a battery voltage of the battery by a predefined voltage offset; and
in response to detection that the system voltage is less than the battery voltage by the predefined voltage offset, transition the battery charger from the charging mode to a pass-through mode (PTM) that continues to discharge the battery, wherein the PTM causes the battery charger to discharge the battery without performing switching.

16. The apparatus of claim 15, wherein the battery charger comprises a first high side switching element, a second high side switching element, a first low side switching element and a second low side switching element, and the battery charger is configured to turn on the first high side switching element and the second high side switching element and turn off the first low side switching element and the second low side switching element to transition the battery charger from the charging mode to the PTM.

17. The apparatus of claim 15, wherein the battery charger is configured to:
in response to the adapter power reaching the maximum value:
operate a first stage of the battery charger under an input current limit loop;
decrease a midpoint voltage being provided from the first stage to a second stage of the battery charger;
in response to the midpoint voltage being decreased:
operate the second stage under an input voltage loop to maintain the midpoint voltage at an input voltage limit;
decrease the system voltage; and
in response to the system voltage being decreased, decrease the battery charging current.

18. The apparatus of claim 17, wherein the battery charger is configured to:
in response to the start of the PTM, further reduce the midpoint voltage to a target voltage under the PTM; and
regulate the midpoint voltage at the target voltage under the PTM.

19. The apparatus of claim 15, wherein the battery charger is configured to maintain the midpoint voltage at a voltage level greater than the system voltage.

20. The apparatus of claim 15, wherein the charging mode is a narrow voltage direct charging (NVDC) mode and the discharging mode is an NVDC discharging mode.
